(19) United States
(12) Patent Application Publication
(10) Pub. No.: US 2009/0244006 A1
(43) Pub. Date: Oct. 1, 2009

(54) INFORMATION PROCESSING APPARATUS, IMAGE DISPLAY CONTROL METHOD THEREOF, AND IMAGE DISPLAY CONTROL PROGRAM THEREOF

(75) Inventors: Tomohiko NAGASE, Chiyoda-ku (JP); Shusuke Kaneda, Chiyoda-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA PHOTRON, Chiyoda-Ku (JP)

(21) Appl. No.: 12/055,931

(22) Filed: Mar. 26, 2008

(51) Int. Cl. G06F 3/033

(52) U.S. Cl. 345/163; 345/157

(57) ABSTRACT

An information processing apparatus with a display unit includes a display control registration unit which preliminarily registers plural arbitrary settable display control functions, a region division unit which divides a display region on the display unit into plural designated sections corresponding to the plural display control functions, a display control enabling unit which enables the display control function corresponding to the designated section when a pointer displayed on the display region is moved to the designated section, an active function display unit which performs a display indicating that the display control function has been enabled, and a display control execution unit which executes the display control function by operating the pointing device in a state where the pointer is in the designated section after enabling the display control function corresponding to the designated section.

### BACKGROUND OF THE INVENTION

1. Field of the Invention

The present invention relates to an information processing apparatus, an image display control method thereof, and an image display control program thereof. More specifically, the present invention relates to an information processing apparatus, an image display control method thereof, and an image display control program thereof for displaying various images on a display.

2. Description of the Related Art

Images picked up by such medical diagnostic system as the X-ray diagnostic system, the ultrasound diagnostic system, and the MRI (Magnetic Resonance Imaging) diagnostic system are mostly digitized. The aforementioned medical digital image is output to the information processing apparatus such as the general-purpose personal computer via the network, for example, LAN so as to be displayed on the display unit thereof. This makes it possible to allow the diagnosis to be performed quickly and efficiently.

Generally, DICOM (Digital Imaging and COmmunication in Medicine) standard has been applicable to the medical digital image. The DICOM standard includes provisions relevant to various diagnosis support information data in addition to those relevant to the image data such as still and video images. Japanese Unexamined Patent Application Publication No. 2005-103055 discloses the use of the diagnosis support information data which include patient information, for example, name, age, gender and the like of the patient subjected to the imaging, imaging information data, for example, date of imaging, site of the patient body subjected to the imaging, condition and apparatus for the imaging, and image information data, for example, pixel number, bit number, and pixel size of the image.

The medical digital images output from the various medical diagnostic systems are temporarily stored in the storage device such as the HDD installed in the information processing apparatus. The stored medical digital image is replayed and displayed on the display unit of the information processing apparatus so as to be observed by the physician for the diagnosis. The medical digital images output from various medical diagnostic systems may be displayed on the display unit in real time so as to allow the physician to perform the diagnosis simultaneously.

Recently, the technology for forming the medical digital image into the high resolution, colored, 3D, and the motion picture has been tremendously progressed. The technology allows execution of various display control functions to enable the physician to diagnose the patient in further detail by partially enlarging the medical digital image picked up with high resolution, to observe the 3D image from the arbitrary direction, or to observe the details with respect to the movement of the target site of the patient by decreasing the video image replay speed. The use of the medical digital image makes it possible to achieve the advanced and highly reliable diagnosis.

As the display control function of the medical digital image has been getting advanced and diversified, the operation for selecting and setting the required display control function has been widely ranged and complicated as well.

In the generally employed method, the display control function is selected and set using the command bar and the sub-window. For example, when the image size is required to be enlarged or reduced, the “enlarge/reduce” button of the command bar is clicked with the mouse to display the sub-window showing the arrow mark and the slide bar for enlarging/reducing the image. Then the display image size may be enlarged or reduced by clicking the arrow or the slide bar, or dragging.

In order to change the replay speed of the displayed video, the “replay speed” button of the command bar is clicked to display the slide bar. The slide bar is then dragged to change the replay speed.

For the purpose of selecting and setting the display control function, the two- or three-step operation as described above is required, which may disturb the physician who needs concentration to perform the diagnose while observing the medical digital images.

It may be often the case where the physician switches the standard display mode where the command bar and the sub-window are displayed to the full-screen mode in order to observe the medical digital image in further detail. In the full-screen mode, only the medical digital image is displayed over the entire range of the display such that the image of the relevant site of the patient is fully observed without being hidden behind the command bar and the sub-window. Accordingly, the full-screen mode is suitable for fully observing the image of the patient. In order to change the display mode by enabling the display control function like the enlarge/reduce, the display mode has to be returned to the normal mode from the full-screen mode to display the command bar on the screen. Thereafter, the operation for setting and changing the display control function has to be performed. The burden for the operation, thus, is further increased.

A certain physician is likely to use only the specific type of the display control function in the limited way on a daily basis rather than using substantially all the display control functions. The structure which allows all the display control functions to be freely selectable may disturb the operation, thus causing the careless error.

### SUMMARY OF THE INVENTION

Accordingly, it is an object of the present invention to provide an information processing apparatus capable of displaying the medical digital images, an image display control method thereof, and an image display control program thereof for realizing selection and setting of various display control functions quickly with high operability.

The present invention provides an information processing apparatus with a display unit, which includes a display control registration unit which preliminarily registers plural arbitrary settable display control functions, a region division unit which divides a display region on the display unit into plural designated sections corresponding to the plural display control functions which have been registered, a display control enabling unit which enables the display control function corresponding to the designated section when a predetermined pointing device is used to move a pointer displayed on the display region to the designated section, an active function display unit which performs a display indicating that the display control function has been enabled, and a display control execution unit which executes the display control function by operating the pointing device in a state where the pointer is in the designated section after enabling the display control function.

The present invention provides an image display control method of an information processing apparatus with a display unit. The method includes a display control function registration step of preliminarily registering plural arbitrary settable display control functions, a region division step of dividing a display region on the display unit into plural designated sections corresponding to the plural display control functions which have been registered, a display control function enabling step of enabling the display control function corresponding to the designated section when a predetermined pointing device is used to move a pointer displayed on the display region to the designated section, an active function display step of performing a display indicating that the display control function has been enabled, and a display control function execution step of executing the display control function by operating the pointing device in a state where the pointer is in the designated section after enabling the display control function.

The present invention provides an image display control program for an information processing apparatus with a display unit, which allows a computer to execute a method including a display control function registration step of preliminarily registering plural arbitrary settable display control functions, a region division step of dividing a display region on the display unit into plural designated sections corresponding to the plural display control functions which have been registered, a display control function enabling step of enabling the display control function corresponding to the designated section when a predetermined pointing device is used to move a pointer displayed on the display region to the designated section, an active function display step of performing a display indicating that the display control function has been enabled, and a display control function execution step of executing the display control function by operating the pointing device in a state where the pointer is in the designated section after enabling the display control function.

The information processing apparatus capable of displaying the medical images, an image display control method thereof, and an image display control program thereof realize selection and setting of various display control functions quickly with high operability.

### BRIEF DESCRIPTION OF THE DRAWINGS

FIG. 1 is a view mainly showing a system hardware structure of an information processing apparatus according to an embodiment of the present invention;

FIG. 2 is a block diagram showing a structure of a function execution unit of the information processing apparatus according to an embodiment of the present invention;

FIG. 3 is a flowchart of a routine for initial registration of a display control function;

FIGS. 4A to 4C show an example for dividing a display screen into sections corresponding to the display control functions;

FIG. 5 is a flowchart of a routine for executing the display control function of an information processing apparatus according to an embodiment of the present invention; and

FIGS. 6A to 6D show the process of executing the display control function to be displayed on the display unit.

### DETAILED DESCRIPTION

An information processing apparatus, an image display control method thereof, and an image display control program thereof according to an embodiment of the present invention will be described referring to the drawings.

### (1) Structure

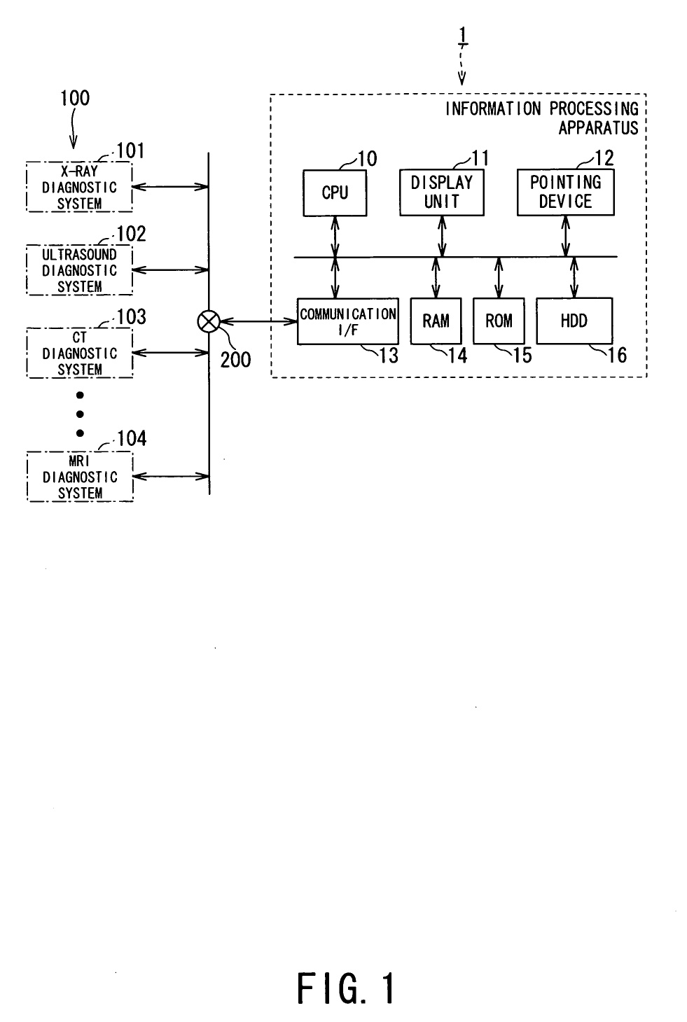

FIG. 1 shows an example of a system structure of an information processing apparatus 1 according to an embodiment and an example of an external device connected to the information processing apparatus 1.

The information processing apparatus 1 is connected to various medical diagnostic systems 100 via an electric communication line 200 such as LAN. The medical diagnostic system 100 includes an X-ray diagnostic system 101, an ultrasound diagnostic system 102, a CT (Computed Tomography) diagnostic system 103, and an MRI diagnostic system 104.

The medical diagnostic system 100 images the patient's body in various modes so as to produce various types of medical digital images. The generated medical digital images are transmitted to the information processing apparatus 1 via the electric communication line 200 together with the diagnosis support information.

As described above, the medical digital image is generated based on the international standard called DICOM standard such that the data are compatible among the medical diagnostic systems 100 of different type and those produced by the different manufacturers. The DICOM standard contains the provisions with respect to various diagnosis support information data in addition to those with respect to the image data such as the still and video images. For example, the diagnosis support information data include the patient information data, for example, name, age, and gender of the patient subjected to the imaging, the imaging information data, for example, date of imaging, site of the patient body subjected to the imaging, condition and apparatus for the imaging, and the image information data, for example, pixel number, bit number and pixel size of the image, which are transmitted to the information processing apparatus 1 together with the image data.

Referring to FIG. 1, the information processing apparatus 1 includes a CPU 10, a display unit 11, a pointing device 12, a communication I/F 13, a RAM 14, a ROM 15, and a HDD 16.

The hardware structure of the information processing apparatus 1 is not specifically limited in the embodiment, but may be formed as the personal computer, for example.

The medical digital images transmitted from the medical diagnostic system 100 are input to the information processing apparatus 1 together with the diagnosis support information via the communication I/F 13, and stored in the memory unit such as the HDD 16. The medical digital images stored in the HDD 16 are displayed on the screen of the display unit 11 based on various display control functions to be described later.

The medical digital images transmitted from the medical diagnostic system 100 may be displayed on the display unit 11 in substantially real time while being stored in the memory unit such as the HDD 16, or without being stored therein.

The display unit 11 includes a display device, for example, the CRT, the liquid crystal display panel, the plasma display panel and the like. The medical digital image, various character information data, and graphic information data are displayed on the display screen.

The pointing device 12 is a device such as the mouse and the touch pad for moving the pointer displayed on the screen of the display unit 11, or generating various control commands to the information processing apparatus 1 by performing such operation as clicking, double clicking, and dragging.

The CPU 10 loads the OS and various types of application software (program) stored in the ROM 15 and the HDD 16 into the RAM 14 so as to be executed. The RAM 14 functions as the work area of the CPU 10.

The information processing apparatus 1 according to the embodiment executes various display control functions, for example, enlargement/reduction, rotation, movement, brightness adjustment, contrast adjustment, video replay speed adjustment, and image selection so as to display the image data such as the medical digital images on the display unit 11. Those functions are executed by the CPU 10 allowed to perform the display control program stored in the HDD 16.

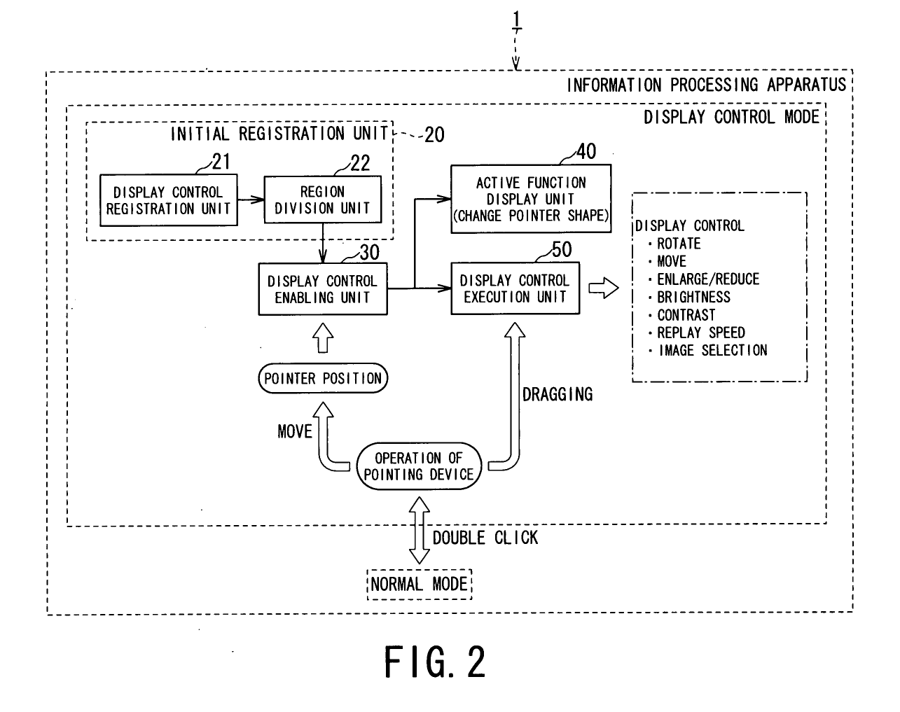

FIG. 2 is a block diagram representing the display control function in the form of plural function execution units of the information processing apparatus 1.

The information processing apparatus 1 includes a display control (function) registration unit 21 for preliminarily registering plural arbitrary settable display control functions, and a region division unit 22 which divides the display region of the display unit 11 into plural designated sections corresponding to the registered plural display control functions, respectively which constitute an initial registration unit 20.

The information processing apparatus 1 includes the function execution units, for example, a display control enabling unit 30 which enables the display control function corresponding to the designated section when the pointer displayed on the display region is moved to the aforementioned designated section using the pointing device 12 such as the mouse, an active function display unit 40 which displays that the display control function has been enabled by the display control enabling unit 30, and a display control execution unit 50 which executes the display control function by operating the pointing device in the state where the pointer is in the designated section after enabling the display control function corresponding to the designated section.

### (2) Operation

Operations of the above-structured information processing apparatus 1, specifically, the operation with respect to the display control of the image data such as the medical digital image will be descried.

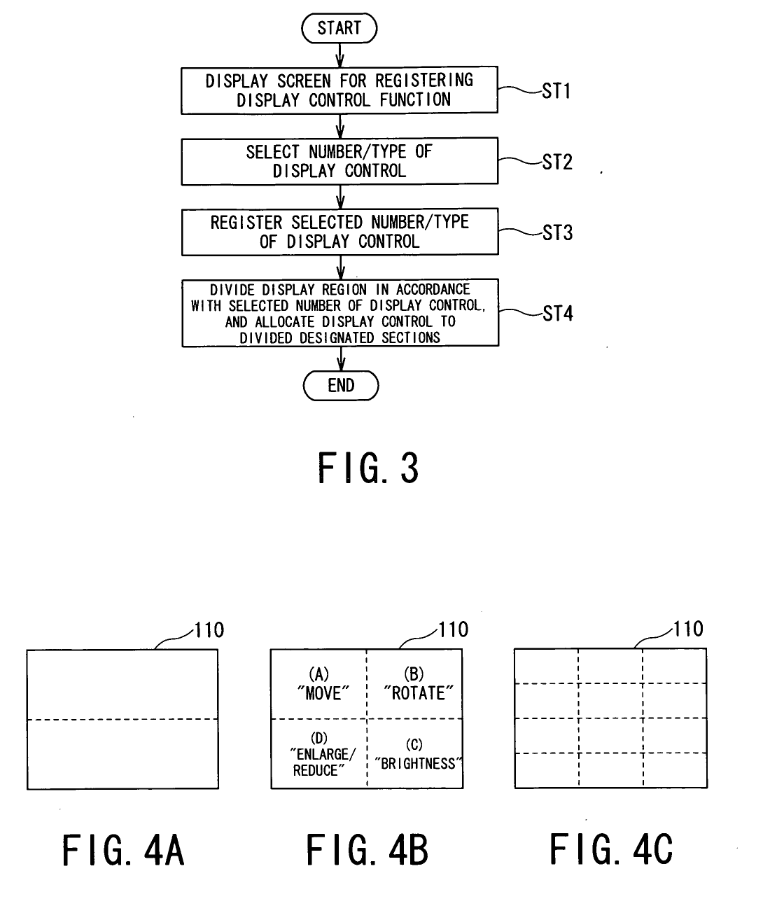

FIG. 3 is a flowchart showing the exemplary process for executing the function performed by the initial registration unit 20.

In step ST1, a screen for registering the display control function (not shown) is displayed on the display unit 11 of the information processing apparatus 1. The display control function herein denotes a control function for operations and adjustments with respect to the display images, for example, “rotation”, that is, clockwise or counterclockwise rotation of the image, “movement” of the image in vertical and horizontal directions, “enlargement/reduction” of the size of the displayed image, adjustment of “brightness” and “contrast” of the image, the image selecting control for selecting the image when the plural images may be displayed, and the adjustment of the replay speed of the moving picture.

In the embodiment, execution of steps ST1 to ST3 allows the user to preliminarily select the desired number and type of the function from various display control functions of the information processing apparatus 1, and to register the selected function therein. The aforementioned process is executed by the display control registration unit 21 shown in FIG. 1.

In step ST1, all the display control functions of the information processing apparatus 1 are displayed on the display unit 11 together with the check box for the respective functions so as to be selected by the user.

In step ST2, the user selects the number and the type of the display control function by clicking the check box corresponding to the desired display control function.

The selected display control function is registered in the information processing apparatus 1 by clicking the predetermined “register” button (not shown) in step ST3.

In most of the cases, the number and the type of the operation or the adjustment selected by the user as the physician with respect to the medical digital images are limited to be in a specific range. Recently, however, the information processing apparatus 1 is capable of performing various types of the display control. When all the display control functions are kept to be operable, the operation becomes complicated, resulting in the risk of careless mistake.

In the present embodiment, the desired display control functions may be preliminarily selected and registered. This makes it possible to simplify the operation, thus preventing the careless errors.

In step ST4, the display screen is divided into plural sections (designated sections) in accordance with the number of the selected and registered display control functions. The selected display control functions are further allocated to the respective divided designated sections.

The number of the selected and registered display control functions is not limited to the specific value. For example, when the number of the display control functions to be selected and registered ranges from 2 to 12, the display screen of the display unit 11 is divided into the designated number of sections.

FIG. 4A shows the screen divided into the sections in accordance with the number of the selected and registered display control functions set to 2. FIG. 4B shows the screen divided into the sections in accordance with the number of the selected and registered display control functions set to 4. FIG. 4C shows the screen divided into the sections in accordance with the number of the selected and registered display control functions set to 12.

The single display control function is allocated to the corresponding divided designated section. For example, when the screen is divided into four sections as shown in FIG. 4B, the “move” function is allocated to the section (A), the “rotate” function is allocated to the section (B), the “brightness” adjustment function is allocated to the section (C), and the “enlarge/reduce” function may be allocated to the section (D), respectively.

The allocation of the function to the divided section may be set by the user upon the initial registration. Alternatively, the respective functions are automatically allocated upon the initial registration by the information processing apparatus 1 such that the user is allowed to change the allocation later.

After the initial registration, the image data such as the medical digital images transmitted from the medical diagnostic system 100 are displayed on the display unit 11 such that the display control function selected and registered with respect to the display image may be executed.

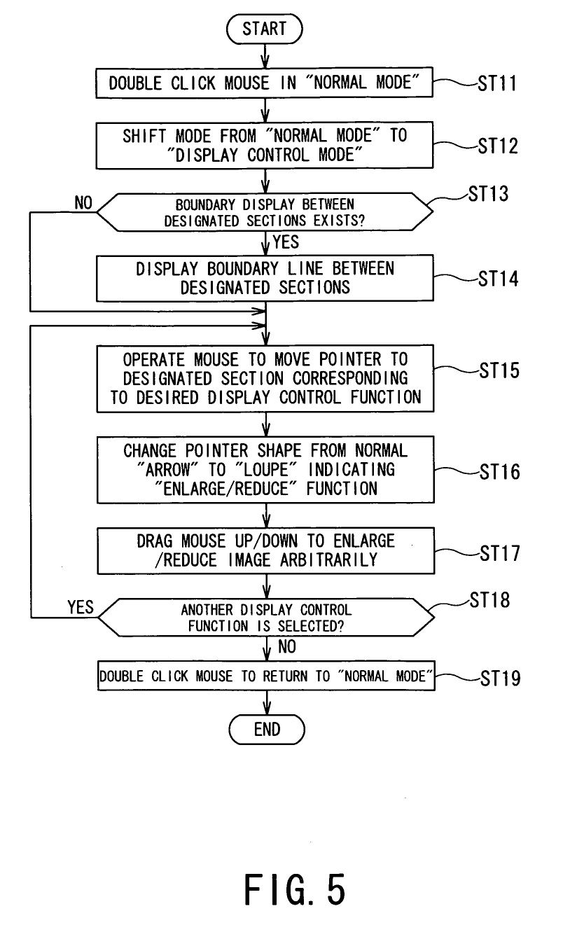

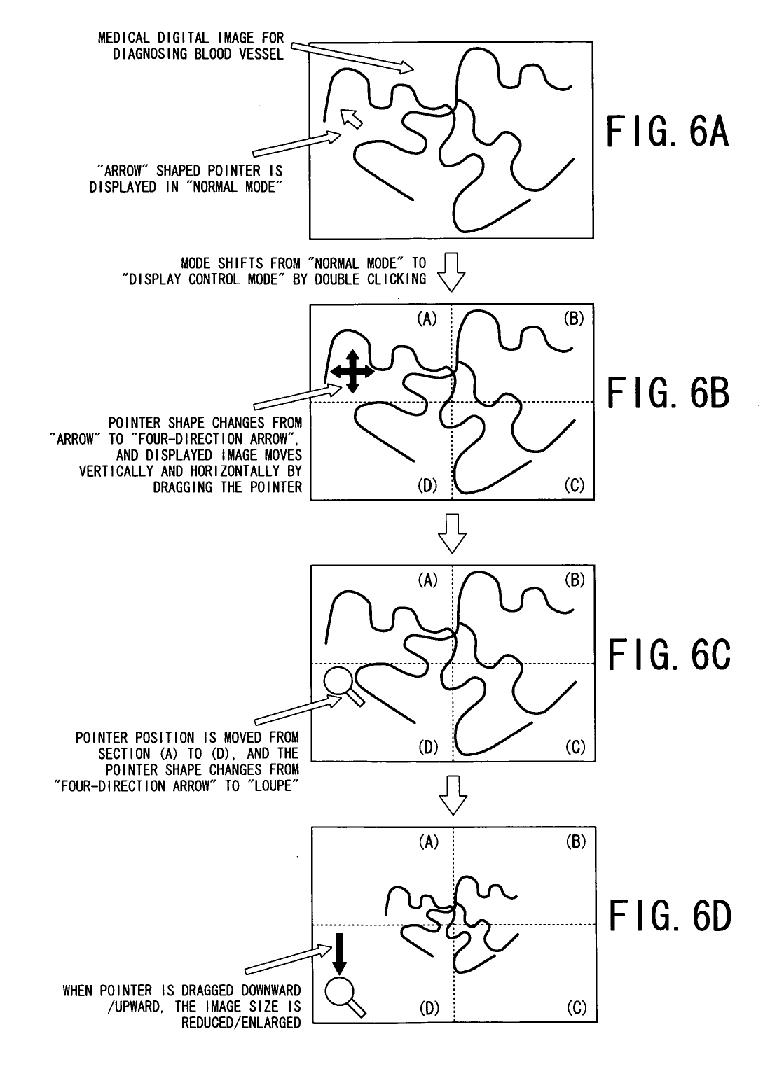

FIG. 5 is a flowchart showing an example of the process for executing the display control function. FIG. 6 shows the example of the display on the display unit 11.

In the following description, the screen display mode which enables the display control function will be referred to as the “display control mode”, and the normal screen display mode before enabling the display control function will be referred to as the “normal mode” hereinafter.

FIG. 6A shows a display example on the display unit 11 in the “normal mode”. The X-ray diagnostic image or the ultrasound diagnostic image with respect to the blood vessel of the patient is shown as the video image.

As the active screen of the display unit 11 is intended to be used to the maximum degree, the “full screen” display mode without displaying the command bar and sub-window is set. The screen displays the pointer which moves in conjunction with the movement of the pointing device 12 such as the mouse. Referring to FIG. 6A, the pointer has an “arrow” shape which indicates the “normal mode”.

In step ST11 shown in FIG. 5, the display mode is shifted from the “normal mode” to the “display control mode” by performing such operation as double clicking the left button of the mouse. Alternatively, the “normal mode” may be shifted to the “display control mode” by clicking the small icon displayed on the corner of the screen for the mode shifting operation.

The display mode of the information processing apparatus 1 is shifted from the “normal mode” to the “display control mode” by double clicking the mouse in step ST12.

Upon shifting to the “display control mode”, as FIG. 6B shows, the display control functions selected/registered upon the initial registration and allocated to the divided designated sections are enabled (active) in accordance with the pointer position to change the shape of the pointer.

The dashed line is used as the boundary line between the designated sections for the purpose of making the respective designated sections easily visible for the user. The boundary between the designated sections may interfere with the observation of the image. So the user is allowed to switch ON/OFF of the boundary display. For example, the small menu for selecting ON/OFF of the boundary display is shown so as to be selected by the user.

In step ST13 shown in FIG. 5, it is determined with respect to ON/OFF of displaying the boundary. Only when it is determined that the boundary display is set to ON, the boundary is displayed in step ST14.

Upon selection of the mode to the “display control mode” by double clicking, the display control enabling unit 30 (see FIG. 1) locates the designated section where the pointer exists upon selection of the mode. The display control function preliminarily allocated to the designated section is selected so as to be enabled.

Referring to FIG. 6B, the pointer position upon selection of the mode to the “display control mode” is in the section (A). So the display control enabling unit 30 identifies the specific display control function allocated to the section (A) so as to be enabled. FIGS. 6A to 6D show the example where four display control functions have been selected/registered upon the initial registration. As described referring to FIG. 4B, the “move” function has been allocated to the section (A). Thus, the “move” function is enabled as the display control function.

The information processing apparatus 1 includes the active function display unit 40 (see FIG. 2) which performs the display to allow the user to recognize the specific display control function which has been enabled. Specifically, the pointer shape currently formed as the “arrow” indicating the “normal mode” is changed to the shape indicating the enabled display control function. In the example shown in FIG. 6B, the pointer shape is changed to the “four-direction arrow”, notifying the user that the “move” function has been enabled.

In the aforementioned state, the mouse is dragged (moving the mouse while pressing the left button) toward the arbitrary direction within the section (A) such that the display image may be moved toward the dragged direction.

Meanwhile, the display control function may be switched to the other display control function by moving the mouse to the other section. For example, as described in FIG. 4B, the “enlarge/reduce” function is allocated to the section (D). When the mouse is moved from the section (A) to (D) without dragging, the currently active function is switched from the “move” to the “enlarge/reduce” as shown in step ST15 of FIG. 5.

The shape of the pointer is changed from the “four-direction arrow” shape to the “loupe” shape indicating the “enlarge/reduce” function in step ST16 as shown in FIG. 6C. Viewing the pointer shape, the user immediately recognizes that the “enlarge/reduce” function has been enabled.

The display control execution unit 50 actually executes the enlarge/reduce function as shown in FIG. 2. When the “loupe” shaped pointer is dragged downward, the display image size is reduced as shown in FIG. 6D. On the other hand, when the “loupe” shaped pointer is dragged upward, the display image size is enlarged in step ST17.

When the user further desires to select another display control function (YES in step ST18), the process returns to step ST15 where the pointer is moved to the section corresponding to the desired display control function such that the process in the flowchart is repeatedly executed until step ST17.

When the user no longer desires to select another display control function (NO in step ST18), the display image may be observed as it is, or the mode may be returned from the “display control mode” to the “normal mode” by double clicking the mouse in step ST19. When the “normal mode” is returned, the display image in the latest set state in the “display control mode” is maintained.

Instead of the double clicking of the mouse, the user is allowed to click the aforementioned mode shifting icon to return the mode from the “display control mode” to the “normal mode”. In any case, the double clicking of the mouse or the clicking of the mode shifting icon with repetition is capable of easily switching the mode between the “display control mode” and the “normal mode”.

The respective steps of the method for processing as shown in FIGS. 3 and 5 may be programmed to execute the aforementioned functions by allowing the CPU 10 (computer) to perform the program.

As described above, the information processing apparatus according to the embodiment, the image display control method thereof, and the image display control program thereof allow the user to select the display control function with easy operation by moving the pointer to the divided sections on the display screen corresponding to the respective display control functions such as the “move”, “enlarge/reduce”, and “rotate”. The selected function may be executed by merely dragging in the divided section.

This makes it possible to largely reduce the burden to the user as the physician who selects and executes the display control function, thus allowing the quick operation. The desired number and the type of the display control function may be selected to the arbitrary values so as to be registered, thus reducing the complicated operation and the error due to the unnecessary function.

In the aforementioned description, the medical digital images are supplied mainly from the medical diagnostic system 100. As has been easily understood from the aforementioned description, the present invention is applicable to the information processing apparatus for processing general digital images.

It is to be understood that the present invention is not limited to the aforementioned embodiment but allows the components to be modified without departing from the scope of the invention in the practical stage. The plural components disclosed in the embodiment may be combined to form various embodiments according to the invention. For example, a certain number of the components may be omitted from all the components described in the embodiment. Alternatively, the components in the different embodiments may be arbitrarily combined.

What is claimed is:

1. An information processing apparatus with a display unit comprising:
a display control registration unit which preliminarily registers plural arbitrary settable display control functions;
a region division unit which divides a display region on the display unit into plural designated sections corresponding to the plural display control functions which have been registered;
a display control enabling unit which enables the display control function corresponding to the designated section when a predetermined pointing device is used to move a pointer displayed on the display region to the designated section;
an active function display unit which performs a display indicating that the display control function has been enabled; and
a display control execution unit which executes the display control function by operating the pointing device in a state where the pointer is in the designated section after enabling the display control function.

2. The information processing apparatus according to claim 1, wherein the active function display unit performs a display indicating that the display control function has been enabled by changing a shape of the pointer before enabling the display control function to another shape indicating the enabled display control function.

3. The information processing apparatus according to claim 1, wherein:
the pointing device is a mouse; and
the mouse is dragged to allow the display control execution unit to execute the display control function.

4. The information processing apparatus according to claim 1, wherein:
the pointing device is a mouse; and
the mouse is double clicked to switch a state between a normal state where the display control function is not enabled and a state where the display control function is enabled.

5. The information processing apparatus according to claim 1, wherein the region division unit further includes a unit for displaying a boundary between the designated sections derived from dividing the display region.

6. An image display control method of an information processing apparatus with a display unit, comprising:
a display control function registration step of preliminarily registering plural arbitrary settable display control functions;
a region division step of dividing a display region on the display unit into plural designated sections corresponding to the plural display control functions which have been registered;
a display control function enabling step of enabling the display control function corresponding to the designated section when a predetermined pointing device is used to move a pointer displayed on the display region to the designated section;
an active function display step of performing a display indicating that the display control function has been enabled; and
a display control function execution step of executing the display control function by operating the pointing device in a state where the pointer is in the designated section after enabling the display control function.

7. An image display control program for an information processing unit with a display unit, which allows a computer to execute a method comprising:
a display control function registration step of preliminarily registering plural arbitrary settable display control functions;
a region division step of dividing a display region on the display unit into plural designated sections corresponding to the plural display control functions which have been registered;
a display control function enabling step of enabling the display control function corresponding to the designated section when a predetermined pointing device is used to move a pointer displayed on the display region to the designated section;
an active function display step of performing a display indicating that the display control function has been enabled; and
a display control function execution step of executing the display control function by operating the pointing device in a state where the pointer is in the designated section after enabling the display control function.
